(19) United States
(12) Patent Application Publication
(10) Pub. No.: US 2011/0164686 A1
(43) Pub. Date: Jul. 7, 2011

(54) METHOD FOR DELIVERY OF DIGITAL LINEAR TV PROGRAMMING USING SCALABLE VIDEO CODING

(76) Inventors: Xiuping Lu, Hillsborough, NJ (US); Shemimon Manalikudy Anthru, Monmouth Junction, NJ (US); David Anthony Campana, Princeton, NJ (US)

(21) Appl. No.: 12/998,041

(22) PCT Filed: Sep. 10, 2009
(86) PCT No.: PCT/US09/05069

§ 371 Date: Mar. 11, 2011

Related U.S. Application Data
(60) Provisional application No. 61/097,531, filed on Sep. 16, 2008.

(51) Int. Cl. H04N 7/26

(52) U.S. Cl. 375/240.25; 375/E07.027

(57) ABSTRACT

A delivery arrangement for linear TV programs uses SVC in which encoded enhancement layer video data is pre-downloaded to a STB and encoded base layer video data is live broadcasted to the STB at viewing time Pre-downloading of the enhancement layer data is done during off-peak viewing periods taking advantage of an abundance of network bandwidth while reducing bandwidth demand during peak viewing periods by broadcasting only the base layer data The enhancement layer data is downloaded in a modified MP4 file and stored in the STB for later synchronization and combination with the base layer, which is sent to the STB in a real time protocol (RTP) stream The combined base and enhancement layer data is SVC decoded for presentation to the enduser The pre-downloaded enhancement video file may be provided with digital rights management (DRM) protection, thereby providing conditional access to the enhanced video

### RELATED PATENT APPLICATIONS

This application claims the benefit under 35 U.S.C. §119(e) of U.S. Provisional Application No. 61/097,531, filed Sep. 16, 2008, the entire contents of which are hereby incorporated by reference for all purposes into this application.

### FIELD OF INVENTION

The present invention generally relates to data communications systems, and more particularly to the delivery of video data.

### BACKGROUND

In existing linear digital television (TV) delivery systems, there is a bandwidth constraint that limits the total number of TV programs available for end-user terminals. As high-definition TV programs become increasingly popular, this bandwidth constraint becomes increasingly noticeable. With more and more bandwidth intensive content such as high-definition (HD) programs competing for prime-time viewers, the available bandwidth during peak-time can become a bottleneck.

During the course of the day, a typical TV broadcasting service will experience widely varying bandwidth demand. For instance, bandwidth demand commonly peaks between 6 PM and 11 PM on weekdays, and 10 AM through 11PM on weekends. At peak times, most if not all available bandwidth is utilized and may even be insufficient under some conditions. At other, off-peak times, however, bandwidth is typically available in abundance.

Thus, while bandwidth at off-peak times may be under-utilized, there may not be sufficient bandwidth available during peak times to meet the end-user demand for Standard Definition (SD) and High Definition (HD) TV programming.

### SUMMARY

In an exemplary embodiment in accordance with the principles of the invention, a delivery method using Scalable Video Coding (SVC) shifts the delivery of peak-time bandwidth-intensive video to off-peak time windows. Previously under-utilized off-peak bandwidth is used advantageously to improve overall delivery efficiency with little or no network upgrade cost.

In particular, the video bitstream produced by an SVC encoder comprises one base layer and one or more enhancement layers. In an exemplary embodiment in accordance with the principles of the invention, the base layer video stream, usually encoded with lower bitrate, lower frame rate, and lower video quality, is live streamed or broadcast to end-user terminals, whereas the one or more enhancement layer video streams are progressively downloaded to end-user terminals before showtime, during off-peak times.

Delivery methods in accordance with the invention can be used for a linear TV service to reduce bandwidth consumption during peak times. In addition, the base layer video can be handled as a basic service whereas the enhancement layer video can be handled as a premium service for its higher video quality. Digital Rights Management (DRM) or the like can be employed to control access to the enhancement layer video.

In view of the above, and as will be apparent from reading the detailed description, other embodiments and features are also possible and fall within the principles of the invention.

### BRIEF DESCRIPTION OF THE FIGURES

Some embodiments of apparatus and/or methods in accordance with embodiments of the present invention are now described, by way of example only, and with reference to the accompanying figures in which:

FIG. 1 is a block diagram of a typical video delivery environment;

FIG. 2 is a block diagram of an exemplary video delivery system in accordance with the principles of the invention;

FIGS. 3A, 3B and 3C show an exemplary format of a media container file containing SVC enhancement layer video information;

FIG. 4 shows an exemplary format of a packet stream for carrying SVC base layer video information;

FIG. 5 shows a flowchart of an exemplary method of operation of a receiving device in an exemplary embodiment of the invention; and

FIG. 6 illustrates the synchronization of streamed base layer data with pre-downloaded enhancement layer data.

### DESCRIPTION OF EMBODIMENTS

Other than the inventive concept, the elements shown in the figures are well known and will not be described in detail. For example, other than the inventive concept, familiarity with television broadcasting, receivers and video encoding is assumed and is not described in detail herein. For example, other than the inventive concept, familiarity with current and proposed recommendations for TV standards such as NTSC (National Television Systems Committee), PAL (Phase Alternation Lines), SECAM (SEquential Couleur Avec Memoire) and ATSC (Advanced Television Systems Committee) (ATSC), Chinese Digital Television System (GB) 20600-2006 and DVB-H is assumed. Likewise, other than the inventive concept, other transmission concepts such as eight-level vestigial sideband (8-VSB), Quadrature Amplitude Modulation (QAM), and receiver components such as a radio-frequency (RF) front-end (such as a low noise block, tuners, down converters, etc.), demodulators, correlators, leak integrators and squarers is assumed. Further, other than the inventive concept, familiarity with protocols such as Internet Protocol (IP), Real-time Transport Protocol (RTP), RTP Control Protocol (RTCP), User Datagram Protocol (UDP), is assumed and not described herein. Similarly, other than the inventive concept, familiarity with formatting and encoding methods such as Moving Picture Expert Group (MPEG)-2 Systems Standard (ISO/IEC 13818-1), H.264 Advanced Video Coding (AVC) and Scalable Video Coding (SVC) is assumed and not described herein. It should also be noted that the inventive concept may be implemented using conventional programming techniques, which, as such, will not be described herein. Finally, like-numbers on the figures represent similar elements.

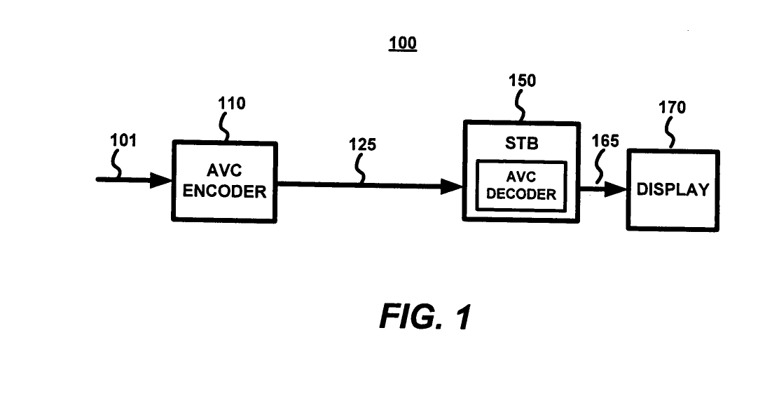

Most TV programs are currently delivered in a system such as that depicted in FIG. 1. In the system 100 depicted, an Advanced Video Coding (AVC)/MPEG-2 encoder 110 receives a video signal 101 representing, for example, a TV program, and generates a live broadcast signal 125 for distribution to one, or more, set-top boxes (STBs) as represented by STB 150. The latter then decodes the received live broadcast signal 125 and provides video signal 165, such as high-definition (HD) or standard-definition (SD) video, to a display device 170, such as a TV, for display to a user. All of the information needed by STB 150 to generate video signal 165 is broadcast live via signal 125. Signal 125 may be conveyed by any suitable means, including wired or wireless communications channels.

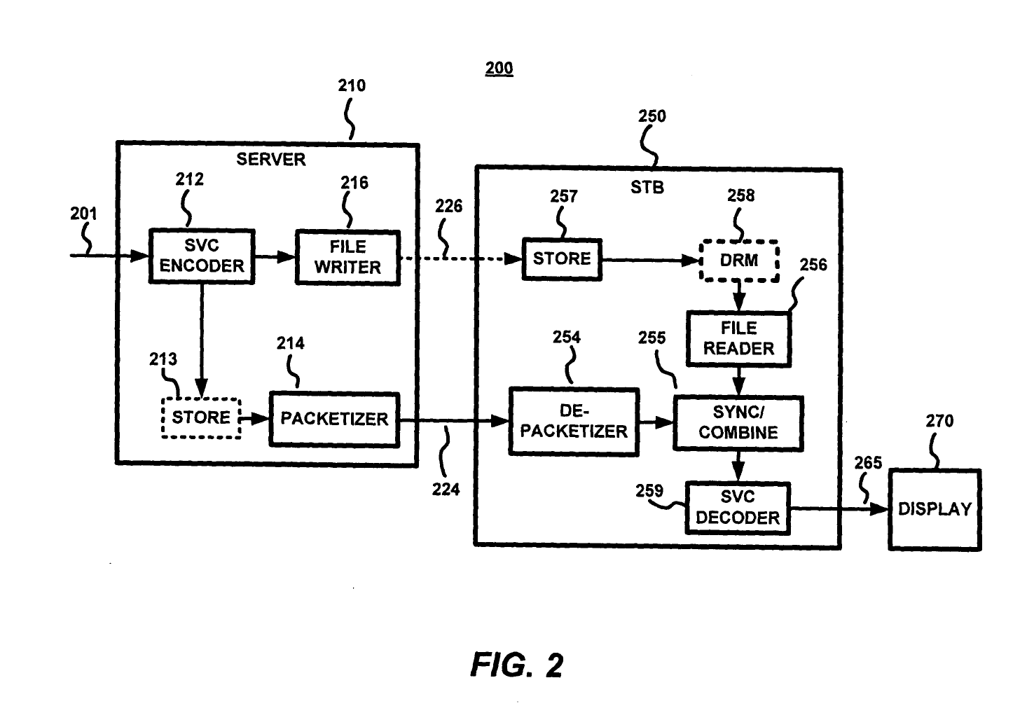

FIG. 2 depicts an exemplary system 200 in accordance with the principles of the invention, in which encoded video is delivered from a video server 210 to end-user terminals such as STB 250 using advanced coding technology such as Scalable Video Coding (SVC). Based on video signal 201, SVC encoder 212 of server 210 generates at least two spatially scalable video layer streams: one base layer stream with SD resolution at a lower bitrate, and one enhancement layer stream with HD resolution at a higher bitrate. Video signal 201 represents, for example, a HD TV program. The SVC base and enhancement layers are conveyed to STB 250 via streams 224 and 226, respectively. Although illustrated herein in terms of spatial scalability (e.g, SD vs. HD), the principles of the invention can be applied to the temporal and quality modes of SVC scalability, as well.

As contemplated by the invention, the different SVC layers are delivered to end-user terminals at different times. In an exemplary embodiment, SVC enhancement layer stream 226 is sent to STB 250 during off-peak hours whereas the corresponding base layer stream 224 is sent to STB 250 at viewing time; i.e., when video signal 265 is generated by STB 250 for display by display device 270 to the end user. It is contemplated that viewing time may occur at any time of the day, including during peak bandwidth demand hours.

The enhancement layer stream 226 may be sent to STB 250 at the time of encoding, whereas the base layer stream 224, which is sent later in time, will be stored, such as in storage 213, and read out of storage for transmission to STB 250 at viewing time. Alternatively, the video signal 201 can be re-played and encoded again at viewing time, with the base layer stream 224 sent as it is generated by encoder 212, thereby eliminating storage 213. Although not shown, the enhancement layer stream 226 may also be stored after it is generated and read out of storage at the time it is sent to STB 250. Any suitable means for storage and read out can be used for stream 224 and/or 226.

The different layer video streams 224, 226 may be delivered using different transport mechanisms (e.g., file downloading, streaming, etc.) as long as the end-user terminals such as STB 250 can re-synchronize and combine the different video streams for SVC decoding. Also, although illustrated as separate streams, the streams 224 and 226 may be transported from server 210 to STB 250 using the same or different physical channels and associated physical layer devices. In an exemplary embodiment, streams 224 and 226 may also be transmitted from different servers.

STB 250 re-synchronizes and combines the two streams for decoding and generates therefrom video 265 for presentation by display device 270. It is contemplated that video signal 265 is generated as the base layer stream 224 is received by STB 250. As discussed, the enhancement layer stream 226 will be received at an earlier time than the base layer stream 224, in which case the enhancement layer stream 226 will be stored in memory 257 until it is time to combine the two streams at 255 for decoding by SVC decoder 259. Normally, the enhancement layer stream 226 is completely stored before any data of the base layer stream 224 has been received.

In an exemplary embodiment, the enhancement layer stream 226 is formatted as a media container file, such as an MP4 file or the like, which preserves the decoding timing information of each video frame. File writer block 216 of server 210 formats the enhancement layer stream generated by SVC encoder 212 into said media container file. This file is downloaded to STB 250 and stored at 256. At or shortly before decoding time, file reader block 256 of STB 250 extracts the enhancement layer video data and associated timing information contained in the downloaded media container file. The operation of file writer 216 and file reader 256 are described in greater detail below with reference to a modified MP4 file structure.

When the TV program represented by signal 201 is scheduled for showing, the base layer video stream 224 is broadcast to multiple receiving devices such as STB 250 via live broadcasting, network streaming, or the like. In an exemplary embodiment, the broadcasting of the base layer video stream 224 is carried out with real-time protocol (RTP) streaming. RTP provides time information in headers which can be used to synchronize the base layer stream 224 with the enhancement layer data in the aforementioned media container file. At server 210, packetizer 214 formats the SVC base layer into RTP packets for streaming to STB 250. At STB 250, de-packetizer 254 extracts the base layer video data and timing information from the received base layer RTP packet stream 224 for synchronization and combination with the enhancement layer by block 255. The operation of packetizer 214 and de-packetizer 254 are described in greater detail below with reference to an illustrative RTP packet structure.

The enhancement layer file may have digital rights management (DRM) protection. Using conditional access for the enhancement layer video makes it possible to offer the enhanced video as a premium add-on service to the base layer video. For example, HD programming can be provided via conditional access to the enhancement layer, whereas SD programming can be provided to all subscribers via access to the base layer. For those subscribing to HD programming, one or more enhancement layer files will be pre-downloaded to their STBs for all or part of one or more HD programs to be viewed later. Each enhancement layer file may contain data for one or more HD programs or portions of an HD program. Users who do not subscribe to HD programming may or may not receive the enhancement layer data file or may receive the file but not store or decrypt it, based on an indicator or the like. The indicator may be set, for example, based on an interface with the user, such as the user successfully entering a password or access code or inserting a smartcard into their STB, among other possibilities. If the enhancement layer files have DRM protection and STB 250 has been enabled to decrypt them, such decryption takes place at 258 and the decrypted enhancement layer data is then provided to file reader 256. Alternatively, decryption may be carried out by file reader 256. File reader 256 provides the decrypted enhancement layer data to block 255 for synchronization and combination with the base layer data streamed to STB 250 at viewing time. The combined data is then sent to SVC decoder 259 for decoding and generation of video signal 265. An exemplary method of synchronizing and combining an SVC enhancement layer in an MP4 file with a corresponding SVC base layer in an RTP stream is described below.

In an exemplary embodiment, conditional access to enhancement layer features can also be controlled by the synchronization and combination block 255. For example, if digital security features in the enhancement layer media container file indicate that STB 250 has the right to use the enhancement layer data, block 255 will carry out synchronization and combination of the enhancement and base layer data, otherwise, it will skip the synchronization and combination and forward only the base layer data to the SVC decoder 259. The security features may also include an indicator indicating the number of times the enhancement layer can be decoded. Each time the enhancement layer is decoded, the number is decremented until no further decoding of the enhancement layer is allowed.

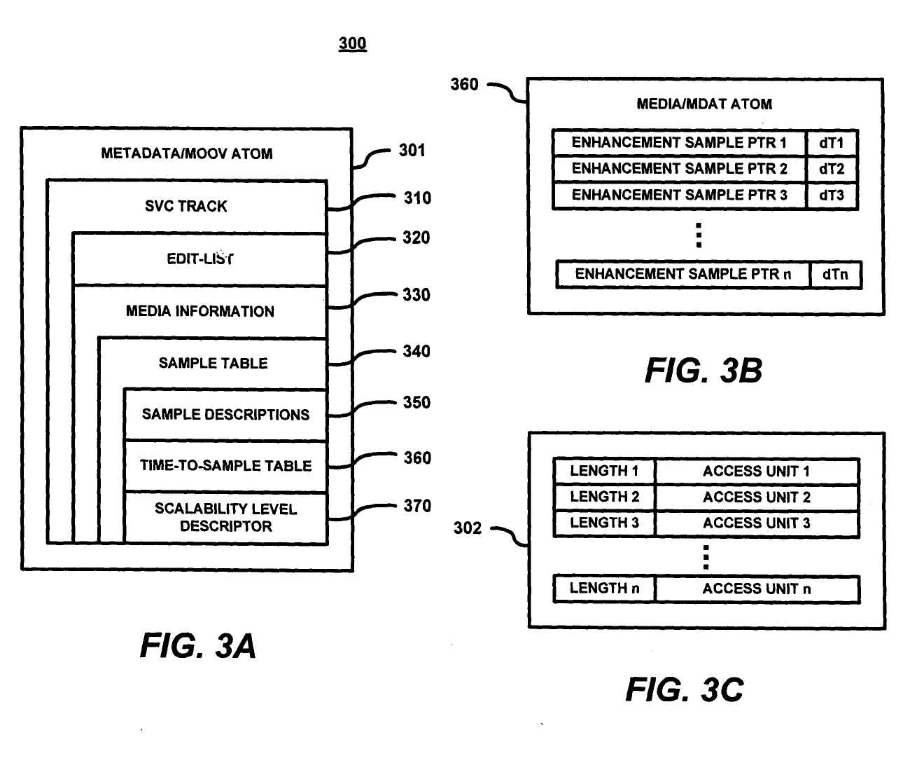

As described above, in an exemplary embodiment of the invention, the base and enhancement layers of the encoded SVC stream are separated into a pre-downloadable MP4 file and a RTP packet stream for live broadcasting, respectively. Although the ISO standards body defines the MP4 file format for containing encoded AVC content (ISO/IEC 14496-15:2004 Information technology—Coding of audio-visual objects—Part 15: Advanced Video Coding (AVC) file format), the MP4 file format can be readily extended for SVC encoded content. FIGS. 3A-3C show an exemplary layout of encoded SVC enhancement layer content in a modified MP4 file.

As shown in FIGS. 3A and 3C, a modified MP4 file 300 as used in an exemplary embodiment of the invention includes a metadata atom 301 and a media data atom 302. Metadata atom 301 contains SVC track atom 310 which contains edit-list 320. Each edit in edit-list 320 contains a media time and duration. The edits, placed end to end, form the track timeline. SVC track atom 310 also contains media information atom 330 which contains sample table 340. Sample table 340 contains sample description atom 350, time-to-sample table 360 and scalability level descriptor atom 370. Time-to-sample table atom 360 contains the timing and structural data for the media. A more detailed view of atom 360 is shown in FIG. 3B. As shown in FIG. 3B, each entry in atom 360 contains a pointer to an enhancement layer coded video sample and a corresponding duration dT of the video sample. Samples are stored in decoding order. The decoding time stamp of a sample can be determined by adding the duration of all preceding samples in the edit-list. The time-to-sample table gives these durations as shown in FIG. 3B.

The media data atom 302 shown in FIG. 3C contains the enhancement layer coded video samples referred to by the pointers in atom 360. Each sample in media data atom 302 contains an access unit and a corresponding length. An access unit is a set of consecutive Network Abstract Layer (NAL) units the decoding of which results in one decoded picture.

Note that the exemplary file format shown in FIGS. 3A-3C contains only SVC enhancement layer data. A file format containing both SVC base and enhancement layer data would include base layer samples interleaved with enhancement layer samples.

With reference to the exemplary system 200 of FIG. 2, when creating a modified MP4 file, such as the file shown in FIGS. 3A-3C, file writer 216 in server 210 copies the enhancement layer NALUs with timing information from SVC encoder 212 into the media data atom structure of the MP4 file. As discussed above, the modified MP4 file is pre-downloaded to STB 250 ahead of the live broadcast of the program to which the file pertains.

File reader 256 in STB 250 performs the reverse function of file writer 216 in server 210. File reader 256 reads the pre-downloaded media container file stored in 257 and extracts the enhancement layer NALUs with the timing information in atom 360 (FIGS. 3A, 3B) and scalability level descriptor in atom 370 as defined in ISO/IEC JTC1/SC29/WG11 CODING OF MOVING PICTURES AND AUDIO (ISO/IEC 14496-15 Amendment 2—Information technology—Coding of audio-visual objects—File format support for Scalable Video Coding).

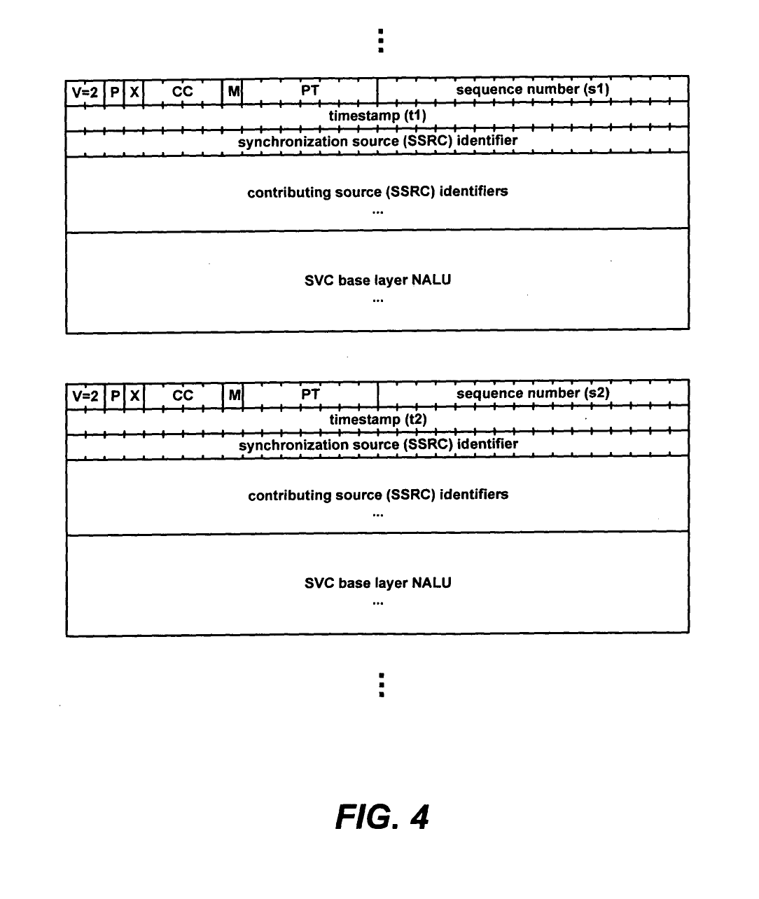

The packetization and transport of an SVC encoded stream over RTP has been specified by the IETF (see, e.g., RTP Payload Format for SVC Video, IETF, Mar. 6, 2009.) Base and enhancement layer NALUs can be packetized into separate RTP packets. FIG. 4 shows an RTP packet stream that carries only the SVC base layer, in accordance with an exemplary embodiment of the invention. The RTP timestamp of each packet is set to the sampling timestamp of the content.

With reference to the exemplary system 200 of FIG. 2, packetizer 214 of server 210 packetizes the SVC base layer NALUs according to the RTP protocol with timing information copied into the RTP header timestamp field. De-packetizer 254 reads packets received by STB 250 from the STB's network buffer (not shown) and extracts the base layer NALUs with their associated timing information.

Based on the timing information extracted therefrom, synchronization and combination module 255 in STB 250 synchronizes and combines the base and enhancement layer NALUs from de-packetizer 254 and file reader 256. After synchronization, each base layer NALU de-packetized from the live RTP stream and the corresponding enhancement NALU extracted from the pre-downloaded MP4 file are combined. In an exemplary embodiment, combining the base and enhancement layer NALUs may include presenting the NALUs in the correct decoding order for decoder 259. The combined NALUs are then sent to decoder 259 for proper SVC decoding.

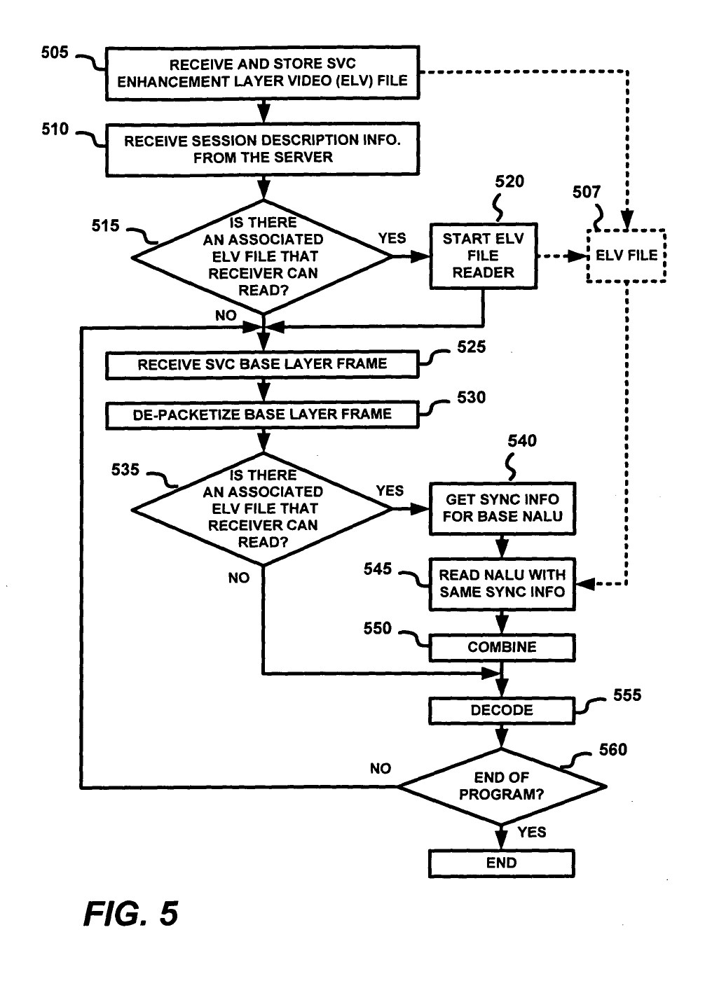

A flow chart of an exemplary method of operation of a receiving device, such as STB 250, in accordance with the principles of the invention is shown in FIG. 5. At 505, the STB receives and stores an enhancement layer video (ELV) file 507, such as from server 210, for a program to be viewed later. At 510, prior to the viewing time of the aforementioned program, STB 250 receives from server 210 a session description file, such as in accordance with the session description protocol (SDP) described in RFC 2327, regarding the program. The SDP file can also specify the presence of one or more associated enhancement layers and their encryption information. At 515, the STB determines whether it has an associated ELV file for the program and whether it is enabled to decrypt and read it, as in the case where the ELV file is protected by DRM tied to a premium service subscription, as discussed above. If yes, an ELV file reader process is started at 520, such as the file reader function 256 discussed above.

At 525, the STB receives a frame of SVC base layer packet(s), such as by RTP streaming. Each base layer frame may be represented by one or more packets, such as those shown in FIG. 4. At 530, the base layer frame is de-packetized for further processing. As shown in FIG. 4, each base layer RTP packet contains an RTP header and an SVC base layer NALU. If, as determined at 535, there is an associated ELV file and the STB is enabled to read it, operation proceeds to 540 in which synchronization information is extracted from the de-packetized base layer frame. Such synchronization information may include, for example, the RTP timestamp in the header of the base layer packet(s) of the frame. At 545, NALUs of an enhancement layer access unit having timing information matching that of the base layer frame are read from the ELV file 507. An exemplary method of identifying corresponding enhancement layer NALUs based on timing information is described below. The base layer NALU(s) and the matching enhancement layer NALU(s) are combined at 550, i.e., properly sequenced based on their timing information, and the combination decoded at 555 for display.

At 535, if there is no ELV file associated with the program whose base layer is being streamed to the STB, or the STB is not enabled to read it, operation proceeds to 555 in which the base layer frame alone is decoded for viewing.

At 560, a determination is made as to whether the program has come to an end. The program comes to an end when base layer packets for the program are no longer received. If not, operation loops back to 525 to receive the next base layer frame and the above-described procedure is repeated, otherwise the process of FIG. 5 ends. If the ELV file 507 is completely read before the end of the program, either another ELV file is read, if available, or operation can proceed to decode the base layer alone, without enhancement.

Though the above example is given using MP4 and RTP, the synchronization mechanism may be applied, for example, to MP4 and MPEG2-TS, among other standard formats.

For applications with multiple enhancement layers, all enhancement layers can be pre-downloaded in one or more files, with the base layer being streamed. Alternatively, one or more enhancement layers can be pre-downloaded and one or more enhancement layers streamed along with the base layer.

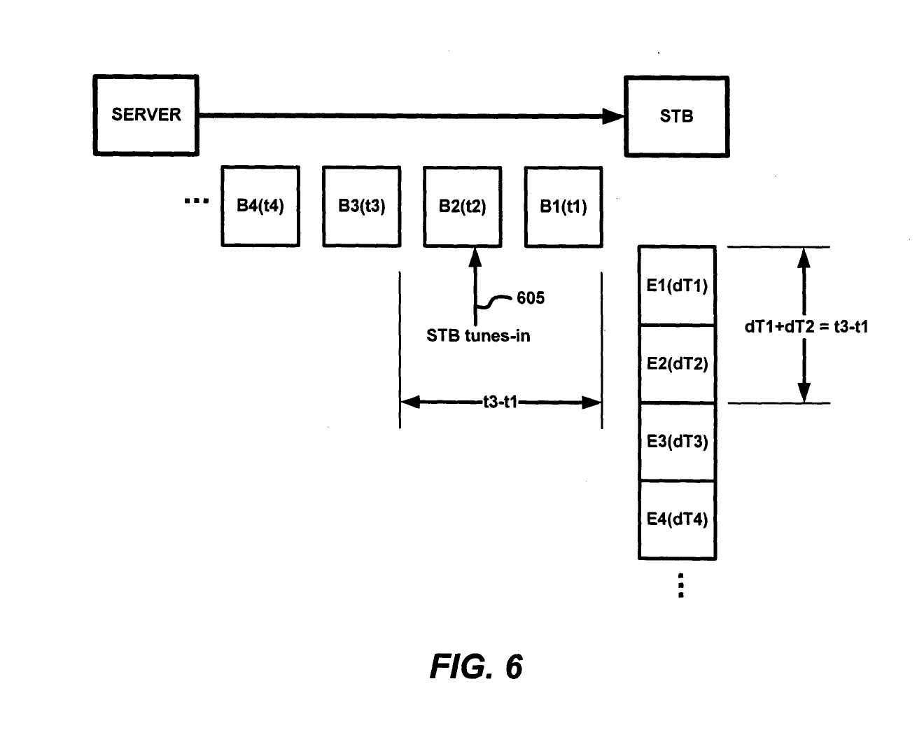

FIG. 6 illustrates an exemplary method of identifying enhancement layer data in a pre-downloaded media container file, such as the above-described modified MP4file, corresponding to base layer data received in an RTP stream. As base layer RTP packets Bn are streamed out from the server, the STB tunes into the stream at some time 605 after the start of the stream. Each base layer RTP packet Bn has an RTP timestamp to which is referenced to the timestamp of the first packet in the stream, B1 (e.g., t1=0).

As shown in the illustration of FIG. 6, the STB tunes-in during the streaming of base layer packet B2. In order to properly decode the stream, however, the STB must receive an access point, which occurs when packet B3 is received. The timestamp of packet B3 is used to find the corresponding enhancement layer data E3 in the media container file. In other words, the enhancement layer data sample which is tn−t1 from the start of the track timeline in the media container file will correspond to base layer packet Bn. Where the data samples are tabulated with their corresponding durations, as in the modified MP4 format described above, the durations of the preceding sample are summed to determine a data sample's temporal displacement from the start of the track timeline—in other words, the data sample's equivalent of an RTP timestamp. Thus as shown in FIG. 6, E3 is determined to correspond to B3 because the sum of the durations of E1 and E2, dT1+dT2, equals t3−t1, the temporal displacement of B3 from the start of the base layer RTP stream. As such, the synchronization and combination module (255) of the STB uses the RTP timestamp of the first access point packet (Bn) from the live streaming broadcast as its reference point to determine the temporal displacement of the packet from the start of the RTP stream (i.e., tn−t1). Then the synchronization and combination module checks the time-to-sample table (360) of the pre-downloaded enhancement layer media container file and searches for the enhancement layer sample which has the same or substantially the same temporal displacement from the start of the track timeline. In the illustration of FIGS. 6, B3 and E3 represent the first base and enhancement layer data to be synchronized and provided together for SVC decoding.

In view of the above, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied in one, or more, integrated circuits (ICs). Similarly, although shown as separate elements, some or all of the elements may be implemented in a stored-program-controlled processor, e.g., a digital signal processor or a general purpose processor, which executes associated software, e.g., corresponding to one, or more, steps, which software may be embodied in any of a variety of suitable storage media. Further, the principles of the invention are applicable to various types of wired and wireless communications systems, e.g., terrestrial broadcast, satellite, Wireless-Fidelity (Wi-Fi), cellular, etc. Indeed, the inventive concept is also applicable to stationary or mobile receivers. It is therefore to be understood that numerous modifications may be made to the illustrative embodiments and that other arrangements may be devised without departing from the spirit and scope of the present invention.

1. A method of reproducing an encoded digital video signal transmitted in first and second layers, wherein the second layer comprises information for enhancing at least one of a resolution, frame rate and quality of the first layer, the method comprising:
receiving data units of the second layer;
storing the received data units of the second layer;
receiving data units of the first layer corresponding to the data units of the second layer;
combining the data units of the first layer with corresponding data units of the second layer while receiving further data units of the first layer, wherein the data units of the second layer are received and stored before any corresponding data units of the first layer are received; and
generating output video frames by decoding the combined data units.

2. The method of claim 1, wherein the data units of the second layer are stored if an indicator indicates that decoding of the combined data units is allowed.

3. The method of claim 2, further comprising steps of:
receiving a user input to set the indicator to one of allowing to decode the combined data units or disallowing to decode the combined data units.

4. The method of claim 1, further comprising steps of:
identifying a file containing the stored data units of the second layer responsive to receiving data units of the first layer; and
accessing the file for retrieving the data units of the second layer.

5. The method of claim 1, wherein the data units of the first and second layers comprise digital samples and the combining step includes:
identifying digital samples in the first layer and digital samples in the second layer having matching synchronization information.

6. The method of claim 1, wherein the data units of the second layer are contained in a media container file.

7. The method of claim 6, wherein the media container file is an MP4 file.

8. The method of claim 1, wherein the data units of the first layer are transmitted in a stream of packets in accordance with a Real-Time Protocol (RTP).

9. The method of claim 1, wherein the digital video signal is encoded in accordance with Scalable Video Coding (SVC), the first layer being a base layer and the second layer being an enhancement layer.

10. The method of claim 9, wherein the base layer conveys standard definition (SD) video and the enhancement layer conveys high definition (HD) video.

11. Apparatus for reproducing an encoded digital video signal transmitted in first and second layers, wherein the second layer comprises information for enhancing at least one of a resolution, frame rate and quality of the first layer, the apparatus comprising:
a receiver for receiving data units of the first and second layers;
a memory for storing the received data units of the second layer;
a combiner for combining the data units of the first layer with corresponding data units of the second layer while receiving further data units of the first layer, wherein the data units of the second layer are received and stored before any corresponding data units of the first layer are received; and
a decoder for generating output video frames by decoding the combined data units.

12. The apparatus of claim 11, wherein the data units of the second layer are stored if an indicator indicates that decoding of the combined data units is allowed.

13. The apparatus of claim 12, further comprising:
an interface for receiving a user input to set the indicator to one of allowing to decode the combined data units or disallowing to decode the combined data units.

14. The apparatus of claim 11, further comprising:
a file reader for identifying a file containing the stored data units of the second layer responsive to receiving data units of the first layer and accessing the file for retrieving the data units of the second layer.

15. The apparatus of claim 11, wherein the data units of the first and second layers comprise digital samples and the apparatus includes:
a synchronizer for identifying digital samples in the first layer and digital samples in the second layer having matching synchronization information.

16. The apparatus of claim 11, wherein the data units of the second layer are contained in a media container file.

17. The apparatus of claim 16, wherein the media container file is an MP4 file.

18. The apparatus of claim 11, wherein the data units of the first layer are transmitted to the receiver in a stream of packets in accordance with a Real-Time Protocol (RTP).

19. The apparatus of claim 11, wherein the digital video signal is encoded in accordance with Scalable Video Coding (SVC), the first layer being a base layer and the second layer being an enhancement layer.

20. The apparatus of claim 19, wherein the base layer conveys standard definition (SD) video and the enhancement layer conveys high definition (HD) video.

21-30. (canceled)
